(19) United States
(12) Patent Application Publication
(10) Pub. No.: US 2011/0034074 A1
(43) Pub. Date: Feb. 10, 2011

(54) Battery connector

(76) Inventors: Yuan-hi Mai, Tu-Cheng City (TW); Shu-Man Chiang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,308

(22) Filed: Aug. 7, 2009

(51) Int. Cl. H01R 13/648

(52) U.S. Cl. 439/607.01

(57) ABSTRACT

A battery connector includes an insulating housing defining a receiving chamber cutting through a front and a bottom thereof, an electric terminal received in the receiving chamber and a shield shell encircling the insulating housing and spaced from the receiving chamber. The electric terminal has a base portion disposed uprightly in a rear of the receiving chamber, a contact portion extended beyond the front of the insulating housing for contacting an external battery, and a resilient portion connecting the base portion and the contact portion. A bottom of base portion is extended to form a solder portion which includes an L-shaped main body extended downward from a middle of the bottom of the base portion and two supporting bodies extended oppositely from two opposite sides of a horizontal part of the main body.

### BACKGROUND OF THE INVENTION

1. Field of the Invention

The present invention relates to an electrical connector, and more particularly to a battery connector.

2. The Related Art

With the rapid development of information industry, portable electronic devices such as video cameras, personal digital assistants (PDA) and mobile phones are widely used in daily life. A variety of battery connectors that are appeared accompanying with these electronic devices have become integral parts to be installed in these electronic devices.

Generally speaking, a battery connector includes an insulating housing and several electric terminals. The insulating housing defines several receiving grooves for correspondingly receiving the electric terminals therein. The electric terminal has a solder portion soldered to a PCB and a contact portion protruded out of the receiving groove to be connected with an external battery which is capable of providing a power source for the electronic devices.

However, if the electronic device works in a unsettle environment, any vibration may cause the battery connector connected with the external battery insufficiently. Besides, the external battery can only store limited energy, people need change another external battery to make sure the electronic device works normally. When change the external battery, the soldering between the solder portion of the terminal and the PCB may be unfastened because of an interference force between the battery connector and the external battery. This will cause an unstable connection between the battery connector and the PCB.

### SUMMARY OF THE INVENTION

It is an object of the present invention to provide a battery connector which is capable of being soldered to a PCB firmly. The battery connector includes an insulating housing, an electric terminal and a shield shell. The insulating housing defines a receiving chamber cutting through a front and a bottom thereof, then two opposite sidewalls locating the receiving chamber therebetween is formed correspondingly. The electric terminal is received in the receiving chamber. The shield shell encircles the insulating housing and is spaced from the receiving chamber. The electric terminal includes a plate-shaped base portion disposed uprightly in a rear of the receiving chamber, a contact portion extended beyond the front of the insulating housing for contacting an external battery, and a resilient portion connecting the base portion and the contact portion. A bottom of the base portion is extended to form a solder portion. The solder portion includes an L-shaped main body extended downward from a middle of the bottom of the base portion and two supporting bodies extended oppositely from two opposite sides of a horizontal part of the main body for being attached to bottoms of the two opposite sidewalls of the insulating housing by distal portions thereof.

As described above, the supporting bodies of the solder portions are attached to the bottoms of the two opposite sidewalls of the insulating housing to locate the solder portions at the same level. It makes the solder processes easier, meanwhile, it makes the electric terminals soldered to the PCB more firmly.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a battery connector in accordance with the present invention;

FIG. 2 is an exploded view of the battery connector shown in the FIG. 1;

FIG. 3 shows a perspective view of an insulating housing of the battery connector;

FIG. 4 shows a perspective view of an electric terminal of the battery connector; and

FIG. 5 is another angle perspective view of the battery connector.

### DETAILED DESCRIPTION OF THE PREFERRED EMBODIMENT

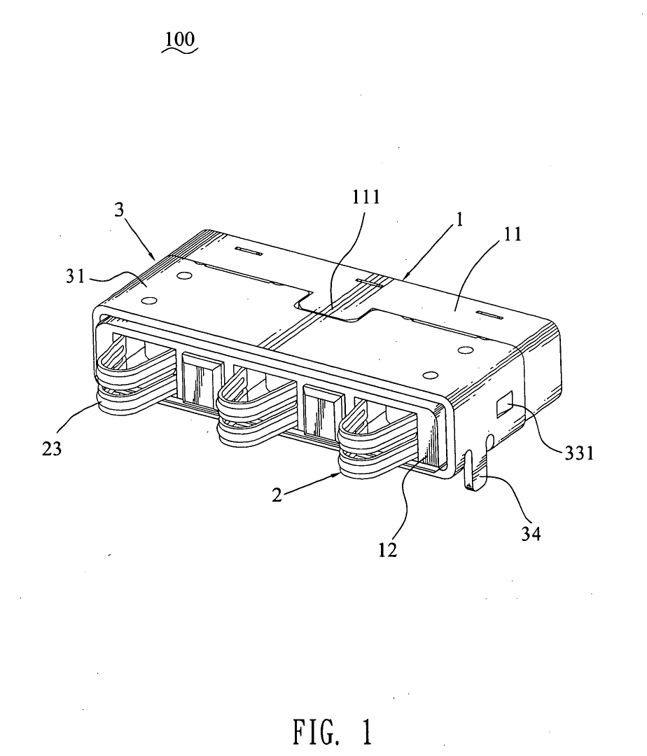

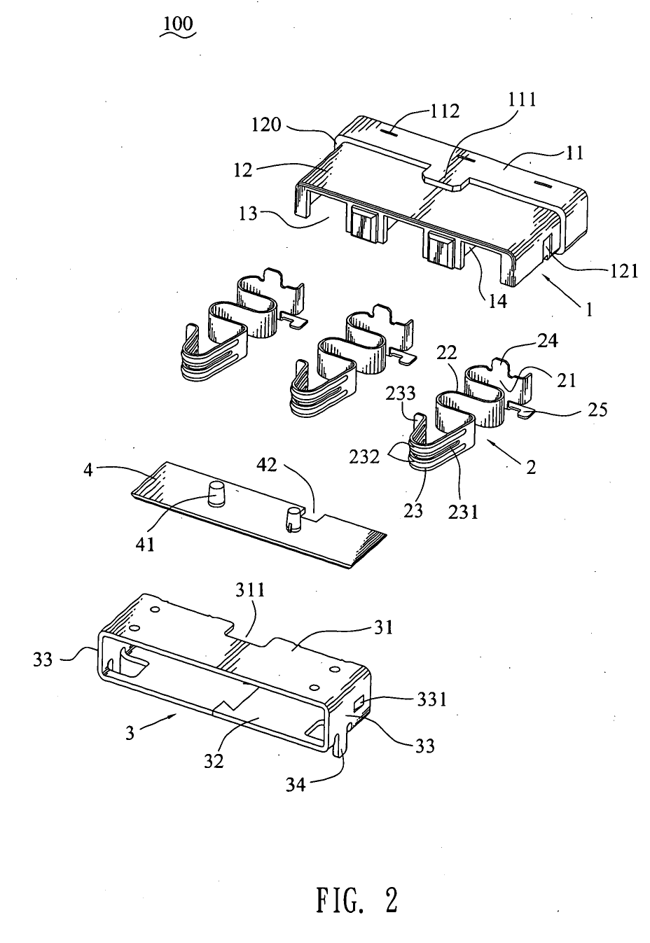

With reference to FIGS. 1 and 2, a battery connector 100 according to the present invention includes an insulating housing 1, a plurality of electric terminals 2, a shield shell 3 and an insulating bottom cover 4.

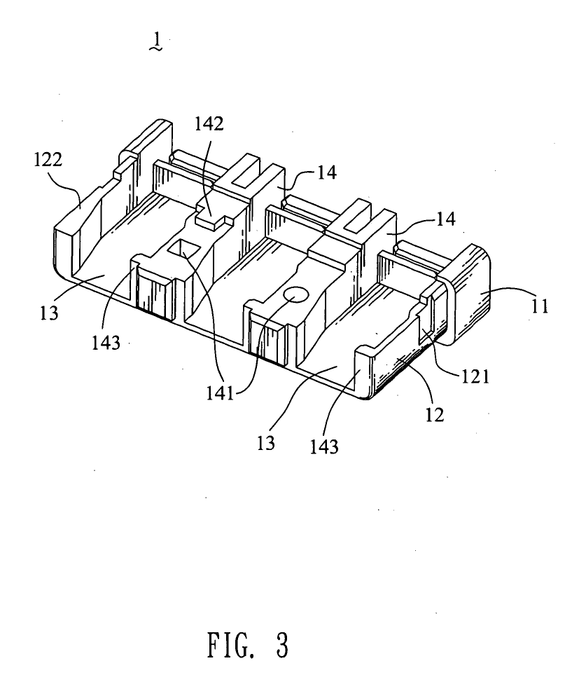

Referring, to FIGS. 2 and 3, the insulating housing 1 is formed as a substantially rectangular figure and includes a rear base 11 and a front base 12 with a dimension less than the rear base 11 extended forward from the rear base 11, then a receiving space 120 is formed around the front base 12 for receiving the shield shell 3. The insulating housing 1 defines a plurality of receiving chambers 13 for receiving the electric terminals 2 therein. The receiving chambers 13 cut through a front and a bottom of the insulating housing 1 and are separated from each other by a partition wall 14. The rear base 11 provides a first protrusion 111 protruded frontward from a middle portion of a top thereof and located on a top surface of the front base 12. Furthermore, the rear base 11 also defines a plurality of fixing slots 112 each cutting through from top to bottom to intersectingly communicate with a rear of the receiving chamber 13. Two opposite sidewalls of the front base 12 respectively define an engagement trough 121 at a rear portion thereof.

The insulating housing 1 further defines an indentation 122 intersecting a bottom of the front base 12 for locating the bottom cover 4. The indentation 122 forms a location hole 141 at each partition wall 14 and a second protrusion 142 protruded frontward from a front surface thereof and located on one of the partition walls 14. Correspondingly, the bottom cover 4 has at least one location pole 41 projected upward and a second opening 42 at a rear edge thereof to correspond with the location holes 141 and the second protrusion 142, respectively. Front ends of the partition walls 14 and one sidewall of the front base 12 respectively project sideward to form a stopper 143 extended into the receiving chamber 13.

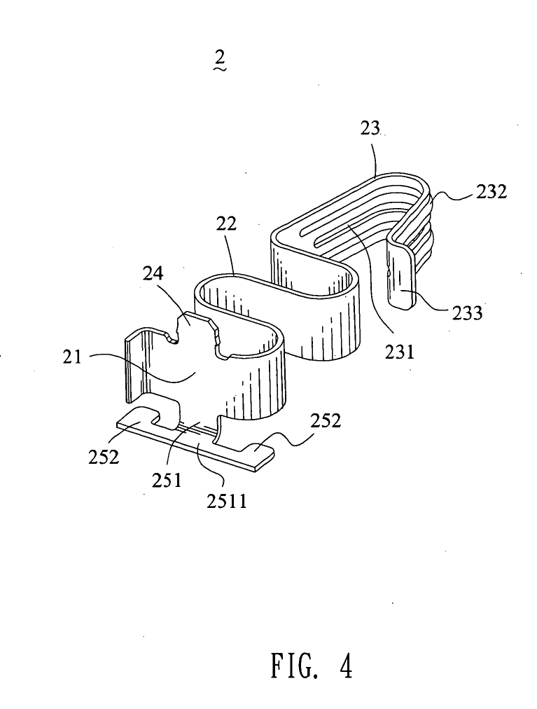

Referring to FIG. 2 and FIG. 4, the electric terminals 2 are correspondingly received in the receiving chambers 13. Each of the electric terminals 2 includes a plate-shaped base portion 21, a resilient portion 22 extended forward from a side edge of the base portion 21 to show a serpentine shape. A free end of the resilient portion 22 is extended forward and then bent rearward to form a contact portion 23 showing a substantially lying-V shape with an opening facing the resilient portion 22. A slit 231 is provided across a bent part of the contact portion 23 to divide the contact portion 23 into an upper and a lower contact region. Each contact region forms a substantially lying-V shaped smooth convexity 232 at an outer surface thereof. A distal end of the contact portion 23 protrudes sideward to form a resistance portion 233. The electric terminal 2 further includes a fixed portion 24 extended upward from a middle of a top of the base portion 21 and a solder portion 25 extended from a bottom of the base portion 21. The solder portion 25 includes an L-shaped main body 251 extended downward from a middle of the bottom of the base portion 21 and two supporting bodies 252 extended oppositely from two opposite sides of a horizontal part 2511 of the main body 251. The supporting body 252 has a bend towards a direction opposite to the bend direction of the main body 251 to show a level-L shape.

Referring to FIG. 2 again, the shield shell 3 has a top plate 31, a bottom plate 32 opposite to the top plate 31, and two opposing side plates 33 connecting the top plate 31 with the bottom plate 32. The top plate 31 defines a first opening 311 at a middle portion of a rear edge thereof to correspond with the first protrusion 111 of the insulating housing 1. The two side plates 33 each defines an engagement piece 331 at a rear portion thereof to correspond with the engagement trough 121 of the insulating housing 1 and an insertion piece 34 extending downward from a front portion thereof to be inserted into a PCB (not shown).

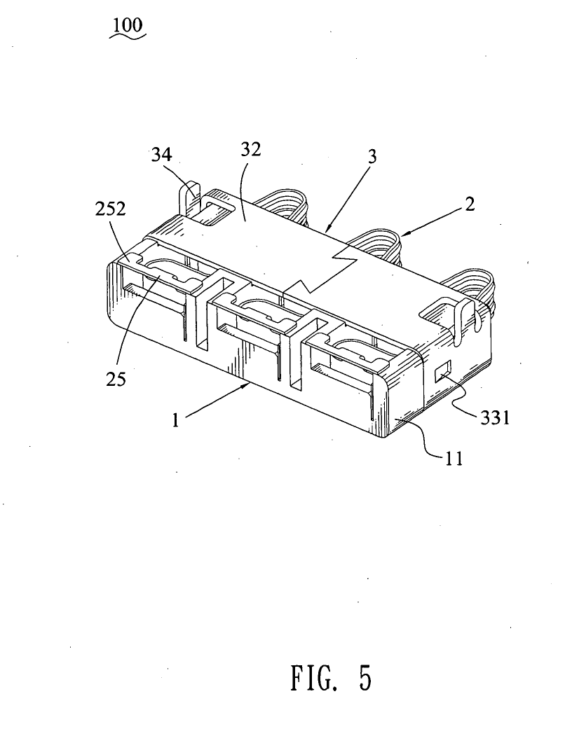

With reference to FIGS. 1, 2 and 5, in assembly, the electric terminals 2 are assembled to insulating housing 1 with the base portions 21 disposed uprightly in the rears of the receiving chambers 13 and the fixed portions 24 inserted into the fixing slots 112. Distal portions of the supporting bodies 252 are respectively attached to bottoms of the neighboring partition walls 14 and sidewalls of the rear base 11. And meanwhile, the resistance portions 233 are tightly against the stoppers 134. In this case, the resilient portions 22 are received in the receiving chambers 13 while the contact portions 23 are extended beyond the front of the insulating housing 1 for contacting an external battery (not shown).

After the electric terminals 2 are assembled to the insulating housing 1, the bottom cover 4 is positioned at the indentation 122 to cover the electric terminals 2. The location poles 41 are inserted into the corresponding location holes 141 and the second opening 42 is engaged with the second protrusion 142, which makes the bottom cover 4 fixed to the insulating housing 1 rapidly and conveniently. Then the shield shell 3 is mounted to the receiving space 120 to encircle the front base 12. The first opening 311 is engaged with the first protrusion 111 and the engagement pieces 331 are buckled into the corresponding engagement troughs 121. Moreover, the bottom cover 4 is arranged between the electric terminals 2 and the shield shell 3 to insulate the electric terminals 2 from the shield shell 3.

The contact portion 23 of each electric terminal 2 has two convexities 232 to contact the external battery, which ensures a stable electrical connection between the electric terminals 2 and the external battery. Besides, the supporting bodies 252 of the solder portions 25 are attached to the bottoms of the neighboring partition walls 14 and sidewalls of the rear base 11 to locate the solder portions 25 at the same level, which provides a convenience to the solder processes, meanwhile, makes the electric terminals 2 soldered to the PCB more firmly.

As described above, the design of two convexities 232 at each contact portion 2 ensures a stable electrical connection between the electric terminals 2 and the external battery. The arrangement of the solder portions 25 attached to the bottoms of the neighboring partition walls 14 and sidewalls of the rear base 11 makes the electric terminals 2 soldered to the PCB quickly and firmly. Therefore, the battery connector 100 can work at a stable status.

What is claimed is:

1. A battery connector, comprising:
an insulating housing, the insulating housing defining a receiving chamber cutting through a front and a bottom thereof, then two opposite sidewalls locating the receiving chamber therebetween being formed correspondingly;
an electric terminal received in the receiving chamber, the electric terminal including a plate-shaped base portion disposed uprightly in a rear of the receiving chamber, a contact portion extended beyond the front of the insulating housing for contacting an external battery, and a resilient portion connecting the base portion and the contact portion, a bottom of the base portion extended to form a solder portion, the solder portion including an L-shaped main body extended downward from a middle of the bottom of the base portion and two supporting bodies extended oppositely from two opposite sides of a horizontal part of the main body for being respectively attached to bottoms of the two opposite sidewalls of the insulating housing by distal portions thereof; and
a shield shell encircling the insulating housing and spaced from the receiving chamber.

2. The battery connector as claimed in claim 1, wherein the supporting body has a bend towards a direction opposite to the bend direction of the main body to show a level L shape.

3. The battery connector as claimed in claim 1, wherein the resilient portion is of serpentine shape and extends from a side edge of the base portion.

4. The battery connector as claimed in claim 3, wherein the contact portion is of substantially lying-V shape with an opening facing the resilient portion.

5. The battery connector as claimed in claim 4, wherein a slit is provided across a bent part of the contact portion to divide the contact portion into two contact regions each of which forms a substantially lying-V shaped smooth convexity at an outer surface thereof.

6. The battery connector as claimed in claim 1, wherein the insulating housing includes a rear base and front base with a dimension less than the rear base extended from the rear base, then a receiving space is formed around the front base for receiving the shield shell.

7. The battery connector as claimed in claim 6, wherein an upper portion of the rear base defines a fixing slot intersectingly communicating with the rear of the receiving chamber, a substantially middle portion of a top of the base portion extended upward to form a fixed portion inserted into the fixing slot.
